(19) United States
(12) Patent Application Publication
(10) Pub. No.: US 2025/0180055 A1
(43) Pub. Date: Jun. 5, 2025

(54) Self-Piercing Rivet and Methods of Making and Using Same

(71) Applicant: Newfrey LLC, New Britain, CT (US)

(72) Inventors: Dominik DOSTAL, Giessen (DE); Matthias WISSLING, Giessen (DE); Andreas SCHMITT, Giessen (DE); Paul BARTIG, Giessen (DE); Joachim SCHNEIDER, Giessen (DE)

(73) Assignee: Newfrey LLC, New Britain, CT (US)

(21) Appl. No.: 19/047,241

(22) Filed: Feb. 6, 2025

Related U.S. Application Data
(63) Continuation of application No. 17/457,500, filed on Dec. 3, 2021, now Pat. No. 12,241,491.
Application No. 17/457,500 is a continuation of application No. PCT/EP2020/059045, filed on Mar. 31, 2020.

(30) Foreign Application Priority Data
Jun. 5, 2019 (EP) 19178449.5

(51) Int. Cl. F16B 19/08

(52) U.S. Cl. CPC F16B 19/086; F16B 19/08

(57) ABSTRACT

A self-piercing rivet with a head and a shank which has a shank diameter (Ds), wherein, at a foot end opposite the head, the shank has an axial recess which has an axial depth (LB), wherein the axial recess has a recess volume, wherein a ratio of recess volume to volume of the shank and the head is in the range of 0.06 to 0.08.

### CROSS-REFERENCE TO RELATED APPLICATIONS

This application is a continuation of U.S. application Ser. No. 17/457,500, filed on Dec. 3, 2021, which is a continuation of International Application No. PCT/EP2020/059045, filed on Mar. 31, 2020, which claims benefit of European Application No. 19178449.5, filed on Jun. 5, 2019. The entire disclosure of each of the above applications is incorporated herein by reference.

### FIELD

The present disclosure relates to self-piercing rivets and methods of making and using the same.

### BACKGROUND

This section provides background information related to the present disclosure which is not necessarily prior art.

The present disclosure relates to a self-piercing rivet with a head and a shank which has a shank diameter, wherein, at a foot end opposite the head, the shank has an axial recess which has an axial depth, and wherein, at the foot end, the shank comprises an annular piercing end, for the production of a joining connection between at least two workpieces. The self-piercing rivet is in particular directed to thin sheet metal application, notably in the automotive industry.

A self-piercing rivet is partially hollow with a head and a cylindrical shank that terminates in an annular edge. As the rivet is driven into at least two overlapping sheets of material over a suitably shaped die, the shank is caused to flare outwardly. The sheets of material are caused to deform around the shank, creating an annulus that encapsulates the shank. The shank and edge of the rivet remain embedded in the sheet material after the rivet has been set. Self-piercing riveting enables sheet material to be joined without the requirement for the pre-drilling or pre-punching of a hole in the material.

One important parameter for the joining operation as well as the joining quality of the self-piercing rivet joint is the geometry of the self-piercing rivet. In the state of the art numerous different geometries of the self-piercing rivet are known, see e.g. EP 0 720 695, EP 1 064 466, EP 1 229 254, EP 1 387 093, DE 44 31 769, DE 203 19 610 U1, DE 200 01 103 U1, US 2004/0068854 A1, JP 2001159409A, JP 09317730A, W2015086203, WO2014013232 or U.S. Pat. No. 9,316,243 et alia.

Self-piercing riveting as a joining method is widely used in the industry and is currently the main joining method for aluminum and lightweight material automotive structures.

WO2014013232 discloses a method for forming a joint in a stack of at least two sheets of light metal alloy, using a self-piercing rivet that is fully hollow. The rivet is coated at least along a portion of its bore by a lubricant and pierces the upper surface thereof and such that the shank deforms outwardly to interlock with the material but without penetration to the die side of the material. The outside diameter of the shank of the rivet is 5.4 mm or less. The die has a volume that is less than 60% or 70% of the effective solid volume of the rivet.

U.S. Pat. No. 9,316,243 describes a self-piercing rivet comprising a head and a substantially cylindrical shank that is at least partially hollow so as to define a bore that extends along at least part of its length, wherein the outside diameter of the shank is at least 6 mm, the effective length of the rivet is at least 1.3 times the diameter of the shank and the bore has a volume that is at least 38% of the effective solid volume of the rivet. Such rivet is suitable for use with thick stack, high strength light metal alloys such as magnesium and aluminum alloys.

However, for doors applications in vehicles, notably for thin aluminum panels, other processes, such as resistance spot welding, compete with self-piercing riveting. Therefore, a need still exists to increase the joining quality and to develop a self-piercing rivet adapted to join workpieces such as door panels and suitable for a simple manufacturing process.

### SUMMARY

This section provides a general summary of the disclosure, and is not a comprehensive disclosure of its full scope or all of its features.

The above-mentioned object is achieved by a self-piercing rivet according to the principles of the present disclosure.

The self-piercing rivet comprises a head and a shank which has a shank diameter, wherein at a foot end opposite the head, the shank has an axial recess which has an axial depth and the shank further comprises an annular piercing edge. The self-piercing rivet is characterized in that the recess has a recess volume, wherein a ratio of recess volume to volume of shank and head is between 0.06 and 0.08.

In other words, the recess has a volume which is between 6% and 8% of the effective solid volume of the rivet or of the total volume of the rivet. Several tests have surprisingly shown that a self-piercing rivet geometry having a ratio of recess volume to volume of shank and head between 0.06 and 0.08 allows to perform a self-piercing rivet having good joining qualities, notably for door panels, and may be easy to manufacture at low costs. Indeed, the geometry and shape of such fastener is similar to the geometry of a clinch rivet or other conventional rivets, allowing an easy manufacturing, but the particular ratio of the rivet according to the present disclosure enables to pierce through the sheets metal and to form an interlock according to the well-known self-piercing method. The self-piercing rivet of the present disclosure thus has at the same time the manufacturing advantages of a clinch rivet although being a self-piercing rivet and providing the joining quality and load bearing capacity of self-piercing rivets known from the state of the art. Thus, such self-piercing rivet is adapted to compete with other joining methods. Such ratio allows a straight upsetting and the spreading through the internal geometry (rivet recess), and not over the outer edge, as known with the rivet from the prior art. The special geometry of the rivet and of its recess allows upsetting and spreading the rivet, without any specific heat or surface treatment. More particularly, no hardening of the rivet is necessary.

Advantageously, the rivet is a cold formed part without any heat or surface treatment. Thus, such self-piercing rivet is easy to manufacture, with a limited number of process steps. The rivet obtains its strength with the cold forming. According to an embodiment, the rivet is manufactured without any hardening step.

Preferably, the recess is arc shaped. For instance, the recess is at least partly arc shaped, notably in the area of the recess base, located toward the head. This shape allows a better forming, notably cold-forming and to limit the cold forming steps.

According to an embodiment, a ratio of recess volume to volume of shank and head ranges between 0.064 and 0.077.

According to an embodiment, the axial depth is defined such as to receive a determined amount of material (remaining bottom) and to weaken the self-piercing rivet over a certain height. A ratio of the axial depth to shank diameter may range between 0.05 and 0.66.

According to an embodiment, the annular piercing edge hat a piercing diameter and the ratio of piercing diameter to shank diameter ranges between 0.85 and 0.99, for example between 0.87 and 0.96. Thus, the position of the piercing edge enables a correct upsetting and spreading of the rivet.

According to an embodiment, the rivet is made of steel, stainless steel or aluminum alloy. More particularly, a rivet made of an aluminum alloy will be used to join aluminum alloy workpieces. For example, the self-piercing rivet is made of precision steel 37MnB4.

According to an embodiment, the self-piercing rivet is made from a wire having a strength of 750 MPa. Such strength is different from the standard strength used in self-piercing rivets. It allows notably to avoid post treatment of the rivet, but it increases the difficulty of generating a sharp edge during the cold forming.

According to an embodiment, the self-piercing rivet comprises a first section in the vicinity of the head and a second section in the vicinity of the annular piercing edge, wherein the material strength of the second section is lower than the material strength of the first section. Due to the cold forming and the recess geometry, the second section is weakened with regard to the first section.

According to an embodiment, the annular piercing edge comprises an outer edge, and wherein the outer edge is sharp-edged with a radius of less than 0.2 mm, and in particular less than 0.1 mm. This sharp-edged outer edge enables to improve the cutting through aluminum alloy panels or workpieces and can be easily manufactured.

According to an embodiment the recess is at least partly conical or frustoconical, such that the recess comprises a conical taper surface, and wherein the conical taper surface has an inclusive angle in cross section between 75 and 105 degrees, and in particular of 90 degrees. Such recess geometry allows a determined spreading in the workpiece.

The present disclosure also relates to a self-piercing riveted joint having an upper workpiece and a lower workpiece from which at least one is realized from a metal, and having a self-piercing rivet as described above, the head of which abuts against the upper workpiece.

According to an embodiment, the upper workpiece and/or the lower workpiece is made of an aluminum alloy. The lower side of the rivet shank is upset and a spreading of the recess geometry of the rivet in the workpiece occurs.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Specific embodiments of the present disclosure will now be described, by way of example only, with reference to the accompanying drawings in which:

FIG. 1 shows schematically a sectioned view of a self-piercing rivet according to the present disclosure.

FIG. 2 shows a sectioned view a riveted join using the piercing rivet of FIG. 1.

Corresponding reference numerals indicate corresponding parts throughout the several views of the drawings.

### DETAILED DESCRIPTION

Example embodiments will now be described more fully with reference to the accompanying drawings.

On the different figures, the same reference signs designate identical or similar elements.

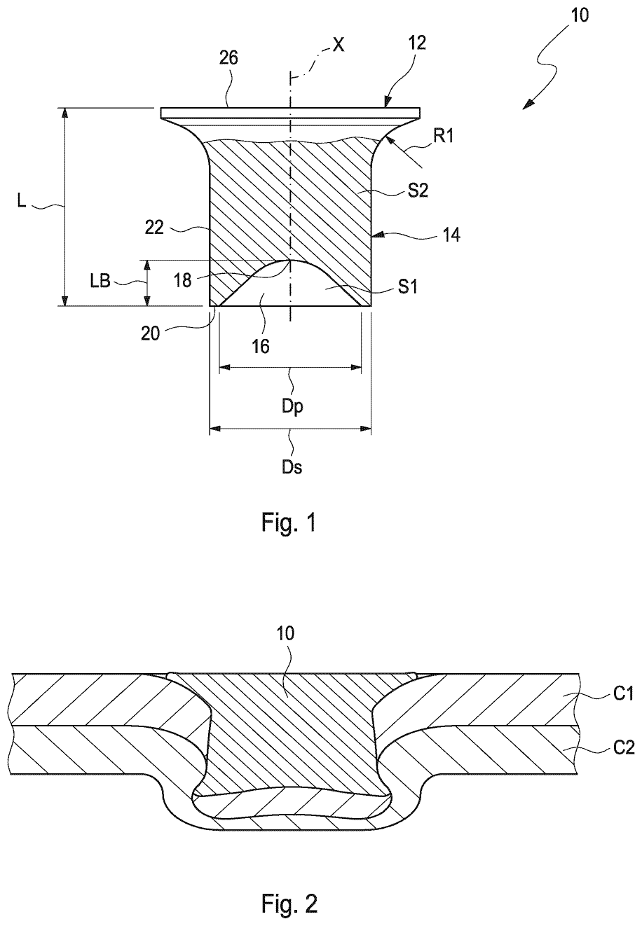

FIG. 1 shows a self-piercing rivet 10 comprising a rivet head 12 and a rivet shank 14 extending along a longitudinal axis X. The self-piercing rivet 10 is suitable for producing a joining connection between at least two components or workpieces C1, C2, as depicted in FIG. 2. For example, one of the workpieces or the two workpieces may be aluminum workpieces, for instance vehicle door panels.

The rivet shank comprises an axial recess (or central bore) 16 having a base 18. The recess 16 is located at the foot end opposite the head 12. The rivet shank 14 further comprises an annular piercing edge 20 facing away from the rivet head 12. The recess 16 comprises an axial depth LB between the base 18 of the recess 16 and the annular piercing edge 20. More particularly the axial depth LB is the greatest distance along the longitudinal axis X between the base 18 and the annular piercing edge 20. For instance, the axial depth LB is the distance between the most upper point of the surface of the base (in other words the point of the base situated the nearest of the upper surface of the head) and the most lower point of the annular piercing edge. The axial depth is for instance of 1 mm.

The recess 16 has a volume and the geometry of the self-piercing rivet is such that a ratio recess volume to volume of the shank and the head (in other word the entire volume of the solid rivet) is between 0.06 and 0.08 or 0.064 and 0.077. More particularly, the ratio can be of about 0.07. In another embodiment, the ratio can be of about 0.065. The recess volume in this case is calculated starting from the foot end of the self-piercing rivet. The volume of the solid rivet is that volume of the rivet shank 14, of the rivet head 12, inclusive a possible transition section to a head of the self-piercing rivet, and excluding the recess volume which is consequently not contained in the volume of the shank.

The rivet shank 14 comprises a cylindrical shank outer surface 22. The shank outer surface has a shank diameter Ds. The shank has a uniform shank diameter. For instance, the shank diameter may be between 3 and 5 mm, and for example of 3.3 mm or 3.5 mm. A ratio of the axial depth LB to shank diameter Ds can range between 0.05 and 0.66.

The rivet head 12 extends radially outward from the rivet shank 14. The rivet head 12 has an upper portion 26 and a transition region defined between the upper portion 26 and the rivet shank 14. The transition region has a radius of curvature R1 in the range 0.5 to 2 mm, for example a radius of curvature of 1 mm or between 0.9 and 1.1 mm. The upper portion 26 has an upper surface opposite the base 18. The thickness of the upper portion 26 is comprised between 0.1 and 0.3 mm, and is notably of 0.25 mm.

The rivet has a length along the longitudinal axis X. The length of the rivet from the annular piercing edge 20 to the head (and more particularly the upper surface of the upper portion of the head 12) is between 3 and 6 mm, or between 3.5 and 5 mm, and for example of 5 or 5.5 mm.

As illustrated in the drawing, the base 18 can be arc shaped. For instance, the base can have a radius between 0.05 of the shank diameter and 4 mm. The radius of the base is for instance of 1.3 mm. The base 18 may also be between conical. More particularly, the base can be arc shaped, and the recess can be partly frustoconical. The recess may comprise conical taper surface having an inclusive angle in cross section between 75 and 105 degrees, and more particularly of 90 degrees.

The annular piercing edge 20 can be a flat shank end face, as depicted in FIG. 1. As shown in FIG. 1, the annular piercing edge comprises an outer edge. The outer edge is sharp-edged with a radius of less than 0.1 mm.

The inner edge forms a cutting line comprising a cutting or piercing diameter.

The cutting line is as sharp as possible, such that a piercing through the workpieces is done without huge setting forces. The ratio of piercing diameter Dp to shank diameter Ds ranges between 0.85 and 0.99, and more particularly between 0.87 and 0.95.

The annular piercing edge 20 may also be an arcuate shank end face. For example, the annular piercing edge may comprise a circular cutter with a cutting diameter, the circular cutter being formed by a cutting line between a radius or a chamfer in the region of an inside surface of the axial recess and a radius toward a radial outside surface of the shank.

The self-piercing rivet is formed by cold forming. No heat or surface treatment is applied to the self-piercing rivet 10 after the cold forming. More particularly, no hardening of the self-piercing rivet is undertaken after the cold forming. Thus, the cold forming gives to the rivet its strength. The self-piercing rivet is for instance made from a wire having a strength of 750 MPa. The manufacturing process through cold forming of self-piercing rivet is well-known by the person skilled in the art and is therefore not detailed.

More particularly, the self-piercing rivet 10 comprises a first section in the vicinity of the head and a second section in the vicinity of the annular piercing edge 20. The strength of the second section is lower than the strength of the first section.

The recess 16 forms a projected surface S1 in a longitudinal cross section plan (as illustrated in FIG. 1). The solid rivet comprises a projected surface S1 in the same plan. The projected surface S2 is that surface formed by the shank 14 and the head 12, including the transition region.

The self-piercing rivet 10 is used in a self-piercing riveted joint, as shown in FIG. 2. The self-piercing riveted joint comprises an upper workpiece C1 and a lower workpiece C2 from which at least one is realized from a metal, and notably in an aluminum alloy. The head 12 abuts against the upper workpiece C1. The lower side of the rivet shank is upset and a spreading of the recess geometry of the rivet in the workpiece occurs. A clean cutting process through the cutting line is performed in the first workpiece.

The self-piercing rivet 10 of the present disclosure, as depicted in FIG. 2, does not comprise a determined spreading due to a thin defined cutting edge (as known for the self-piercing rivet of the state of the art), but the connection or joining of the two workpieces in made through upsetting the rivet by a die in its lower area and the spreading of the rivet through the recess geometry with determined taper surfaces. The self-piercing rivet with the geometry shown in FIG. 1 allows to perform a clean cutting in the joining operation. The internal geometry allows the workpiece material to “slide” and thus forms an internal pressure. The spreading is assisted through the straight upsetting.

Although exemplary embodiments of the present disclosure have been shown and described, it will be appreciated by those skilled in the art that changes may be made to these embodiments without departing from the principles and spirit of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A self-piercing rivet comprising:
a head; and
a shank extending from the head and forming a foot end opposite of the head along the length of the rivet, the shank having an axial recess extending into the foot end and an annular piercing edge extending around the axial recess,
wherein a ratio of a volume of the axial recess to a volume of the shank and the head is in the range of 0.06 to 0.08.

2. The self-piercing rivet of claim 1 wherein the annular piercing edge includes a flat shank end face with an inner edge and an outer edge, and the outer edge is a sharp edge with a radius of less than 0.2 mm.

3. The self-piercing rivet of claim 1 wherein the axial recess has an axial depth, the shank has an outer diameter, and a ratio of the axial depth to the outer diameter is in the range of 0.05 to 0.66.

4. The self-piercing rivet of claim 1 wherein the shank has a piercing diameter at an inner perimeter of the annular piercing edge, the shank has an outer diameter, and a ratio of the piercing diameter to the outer diameter is in the range of 0.85 to 0.99.

5. The self-piercing rivet of claim 1 wherein the shank includes a first section adjacent to the head and a second section adjacent to the foot end, and the material strength of the second section is less than the material strength of the first section.

6. The self-piercing rivet of claim 1 wherein a base of the axial recess is arc shaped in cross section.

7. The self-piercing rivet of claim 6 wherein the rest of the axial recess is frustoconical such that the axial recess has a conical tapered surface, and the conical tapered surface has an inclusive angle in cross section in the range of 75 degrees to 105 degrees.

8. A riveted joint comprising:
a first workpiece;
a second workpiece; and
a self-piercing rivet joining the first and second workpieces together, the rivet including a head and a shank extending from the head and forming a foot end opposite of the head along the length of the rivet, the shank having an axial recess extending into the foot end and an annular piercing edge extending around the axial recess,
wherein, before deforming the rivet to form the riveted joint, a ratio of a volume of the axial recess to a volume of the shank and the head is in the range of 0.06 to 0.08.

9. The riveted joint of claim 8 wherein the head of the rivet abuts the first workpiece, and a distal portion of the shank surrounding the axial recess is flared outward such that the first and second workpieces are interlocked between the head of the rivet and the distal portion of the shank.

10. The riveted joint of claim 8 wherein the annular piercing edge of the rivet pierces completely through the first workpiece such that the annular piercing edge contacts the second workpiece without piercing into the second workpiece.

11. The riveted joint of claim 8 wherein the rivet is made of an aluminum alloy and at least one of the first and second workpieces is made of an aluminum alloy.

12. A method of making a self-piercing rivet, the method comprising:
cold forming the rivet to include a head and a shank extending from the head and forming a foot end opposite of the head along the length of the rivet, the shank having an axial recess and an annular piercing edge extending around the axial recess; and
providing the rivet in its final manufactured state without heat treating the rivet.

13. The method of claim 12 further comprising cold forming the rivet such that a ratio of a volume of the axial recess to a volume of the shank and the head is in the range of 0.06 to 0.08.

14. The method of claim 12 further comprising cold forming the rivet such that the shank includes a first section adjacent to the head and a second section adjacent to the foot end, wherein the material strength of the second section is less than the material strength of the first section.

15. The method of claim 12 further comprising cold forming the rivet from a material having a strength of at least 750 MPa.

16. The method of claim 12 further comprising cold forming the rivet from one of steel or stainless steel or aluminum alloy.

17. A method of making a riveted joint using a self-piercing rivet that is cold formed without any heat treatment, the rivet including a head and a shank extending from the head and forming a foot end opposite of the head along the length of the rivet, the shank having an axial recess extending into the foot end and an annular piercing edge extending around the axial recess, the method comprising:
driving the annular piercing edge of the rivet into a first workpiece until the head of the rivet abuts the first workpiece;
deforming the first workpiece and a second workpiece in the driven direction of the rivet and deforming the rivet, and thereby decreasing the length of the rivet, through contact between the annular piercing edge of the rivet and the first workpiece; and
spreading a distal portion of the shank surrounding the axial recess radially outward and thereby interlocking the first and second workpieces between the head of the rivet and the distal portion of the shank.

18. The method of claim 17 wherein, before deforming the rivet, a ratio of a volume of the axial recess to a volume of the shank and the head is in the range of 0.06 to 0.08.

19. The method of claim 17 further comprising piercing completely through the first workpiece with the annular piercing edge of the rivet such that the annular piercing edge contacts the second workpiece without piercing into the second workpiece.

20. The method of claim 17 wherein the rivet is made of an aluminum alloy and at least one of the first and second workpieces is made of an aluminum alloy.
